(19) United States
(12) Patent Application Publication
(10) Pub. No.: US 2007/0139662 A1
(43) Pub. Date: Jun. 21, 2007

(54) Printing method using pop-up menu and print control apparatus

(75) Inventors: Yong-in Eom, Suwon-si (KR); Dong-kyoo Hong, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/600,748

(22) Filed: Nov. 17, 2006

(30) Foreign Application Priority Data
Dec. 20, 2005 (KR) 2005-126060

(51) Int. Cl. G06F 3/12

(52) U.S. Cl. 358/1.1; 358/1.13

(57) ABSTRACT

A printing method using a pop-up menu and a print control apparatus are disclosed. The print control apparatus for use in a method of printing a file to be printed using a pop-up menu includes a pop-up menu unit for generating the pop-up menu, a display unit for displaying the generated pop-up menu, an input unit for selecting a printer driver and a print option required for a print operation through the pop-up menu, and a communication interface unit for transmitting the selected printer driver and print option to a printer connected to the printer driver. The inventive method and apparatus provide improved control for printing.

### CROSS-REFERENCE TO RELATED APPLICATIONS

This application claims the benefit under 35 U.S.C. §119(a) of Korean Patent Application No. 2005-126060 filed on Dec. 20, 2005, in the Korean Intellectual Property Office, the entire disclosure of which is hereby incorporated by reference.

### BACKGROUND OF THE INVENTION

1. Field of the Invention

The present invention relates to a printing method using a pop-up menu and a print control apparatus. More particularly, the present invention relates to a printing method using a pop-up menu and a print control apparatus, whereby a printer driver and a print option are displayed on a pop-up menu, so that a user may select them to print a file.

2. Description of the Related Art

FIG. 1 is a view illustrating a conventional mouse pop-up menu, and FIG. 2 is a flowchart illustrating a printing method using the conventional mouse pop-up menu of FIG. 1. The printing method using the conventional mouse pop-up menu will be described with reference to FIGS. 1 and 2.

An icon 11 of a file to be printed is clicked by a right mouse button to display a mouse pop-up menu 13 (S21), without opening the file to be printed.

When a “Print” menu 15 of the mouse pop-up menu 13 is clicked (S23), a default profile value is applied to a printer installed in a print control apparatus as a default to print the file immediately. Specifically, the print control apparatus transfers a default profile of the printer driver that drives the corresponding printer and the file to be printed to the printer installed in the print control apparatus as a default (S25).

The printer having received the file to be printed and the profile applies the received profile to print the file (S27).

In the case of printing the file using the mouse pop-up menu, the file to be printed can be immediately printed, without opening the file to be printed. In the case where a user desires to print the file by applying another printer and profile which are different from the printer and the profile set as a default, however, the other printer and profile cannot be utilized. In other words, in order to print the file, the user should open the file to be printed and change the printer and the profile, thereby causing inconvenience in use.

Accordingly, there is a need for an improved control apparatus and method for using a pop-up menu for controlling a printing apparatus.

### SUMMARY OF THE INVENTION

Exemplary embodiments of the present invention address the above drawbacks and other problems associated with the conventional arrangement. Accordingly, an aspect of the present invention is to provide a printing method using a pop-up menu and a print control apparatus, whereby a printer driver and a print option are displayed on the mouse pop-up menu, so that a user can select them to print a file.

The foregoing and other objects and advantages are substantially realized by providing a method of printing a file using a pop-up menu, according to an exemplary embodiment of the present invention, the method comprising displaying a pop-up menu for the file to be printed, receiving a selection of a printer driver and a print option required for a print operation through the pop-up menu and printing the file by applying the selected printer driver and print option.

The displaying of the pop-up menu for the file to be printed may be performed by clicking an icon of the file to be printed using a right mouse button.

The pop-up menu may include a first menu for showing a list of selectable printer drivers and a second menu for showing a list of selectable print options.

In the receiving of the selection of a printer driver and a print option required for a print operation through the pop-up menu the printer driver may be selected from the displayed list of the selectable printer drivers.

Also, the print option may be selected from the displayed list of the selectable print options.

The exemplary method of printing the file may further comprise registering the printer driver in the pop-up menu if the printer driver is installed.

The pop-up menu may include a menu capable of adding or changing the print option, and if the menu capable of adding or changing the print option is selected, the print option may be selected through a user interface capable of adding or changing the print option in the receiving of the selection of the printer driver and the print option required for a print operation through the pop-up menu.

According to another exemplary aspect of the present invention, there is provided a print control apparatus for use in a method of printing a file to be printed using a pop-up menu, which comprises a mouse pop-up menu unit for generating the pop-up menu, a display unit for displaying the generated pop-up menu, an input unit for selecting a printer driver and a print option required for a print operation through the pop-up menu and a communication interface unit for transmitting the selected printer driver and print option to a printer connected to the printer driver.

The input unit may be a mouse.

The pop-up menu may include a first menu for showing a list of selectable printer drivers and a second menu for showing a list of selectable print options.

The input unit may select the printer driver from the displayed list of the selectable printer drivers.

The input unit may select the print option from the displayed list of the selectable print options.

If the printer driver is installed, the mouse pop-up menu unit may register the installed printer driver in the pop-up menu.

The print control apparatus may further comprise at least one printer driver and at least one print option for each printer driver, and the list of the selectable printer drivers may be extracted from the printer driver.

The print control apparatus may further comprise at least one printer driver and at least one print option for each printer driver, and the list of the selectable print options may be extracted from the printer driver.

The pop-up menu may include a menu capable of adding or changing the print option, and if the menu capable of adding or changing the print option is selected, the input unit may select the print option through a user interface capable of adding or changing the print option.

When the print driver is installed as a default, the pop-up menu may include a first menu for showing print options and a second menu for showing a list of print options to add to the first menu.

Furthermore, the second menu may include a check box for selecting the print option on the list to add to the first menu.

In this case, the file to be printed may comprise at least one file.

### BRIEF DESCRIPTION OF THE DRAWINGS

The above aspects and features of the present invention will be more apparent by describing exemplary embodiments of the present invention with reference to the accompanying drawings, in which:

FIG. 1 is a view illustrating a prior art mouse pop-up menu;

FIG. 2 is a flowchart illustrating a printing method using a prior art mouse pop-up menu;

FIG. 3 is a block diagram illustrating the construction of a print control apparatus provided in a printing system according to an exemplary embodiment of the present invention;

FIG. 4 is a flowchart illustrating a printing method according to an exemplary embodiment of the present invention;

FIG. 5 is a views illustrating a mouse pop-up menu according to an exemplary embodiment of the present invention;

FIG. 6 is a view illustrating a method of storing a profile; and

FIG. 7 is a view illustrating a mouse pop-up menu according to an exemplary embodiment of the present invention.

FIG. 8 is a view illustrating a mouse pop-up menu according to an exemplary embodiment of the present invention.

FIG. 9 is a view illustrating a mouse pop-up menu according to an exemplary embodiment of the present invention.

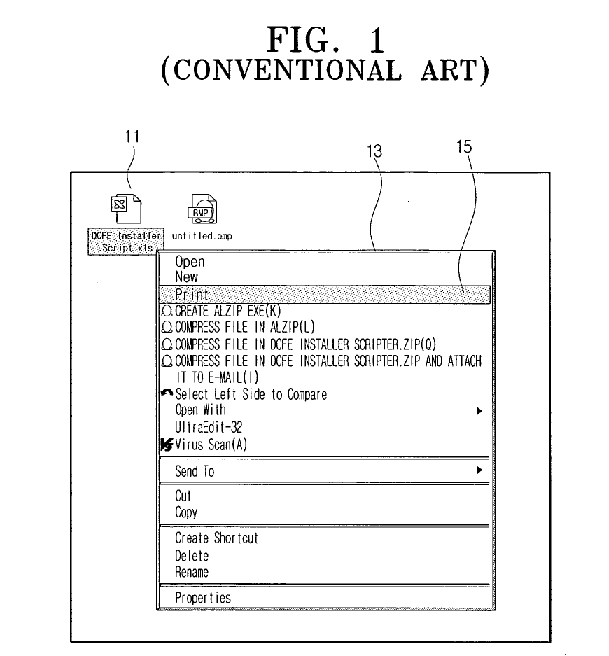

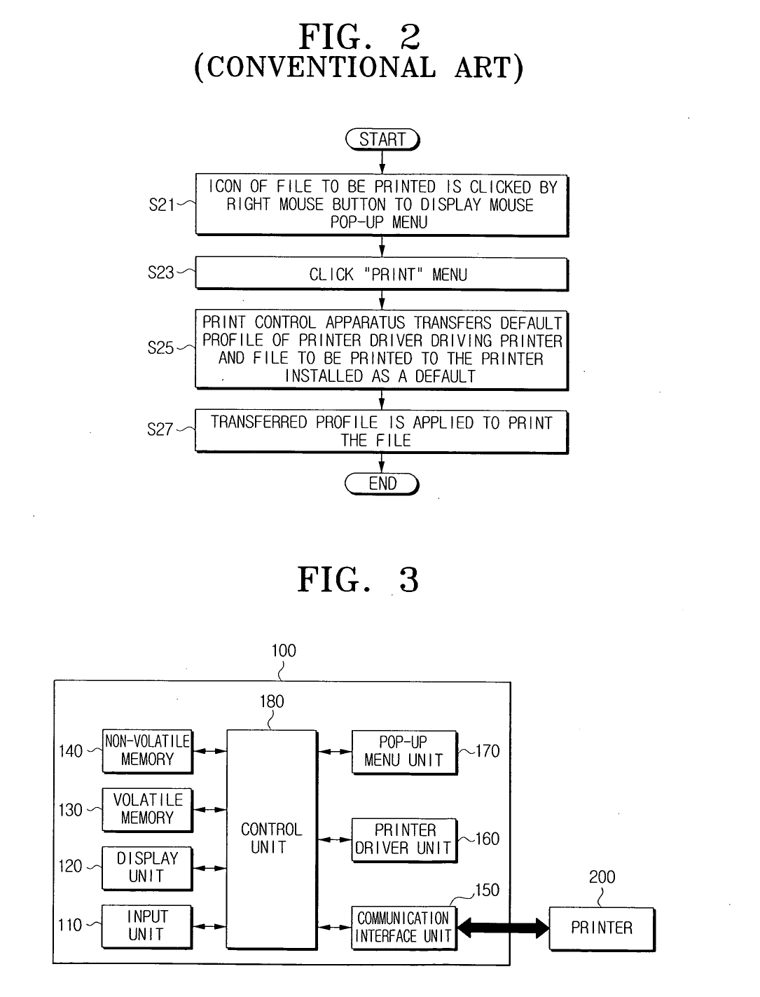

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

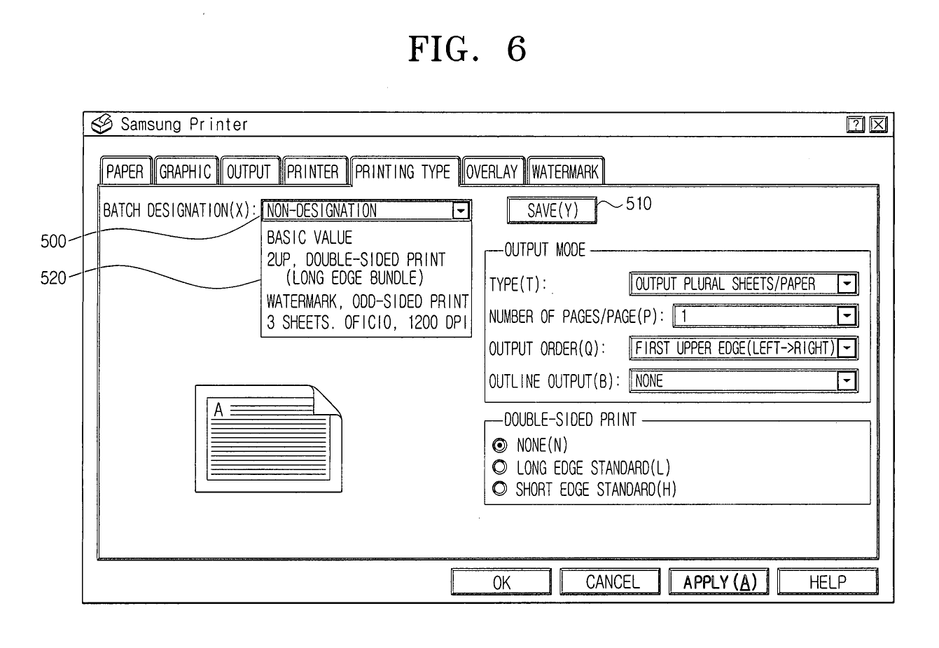

FIG. 3 is a block diagram illustrating the construction of a print control apparatus provided in a printing system according to an exemplary embodiment of the present invention, and FIG. 5 is a view illustrating a pop-up menu according to an exemplary embodiment of the present invention. The print control apparatus according to an exemplary embodiment of the present invention will now be described with reference to FIGS. 3 and 5.

The printing system includes a printer 200 that receives a document to be printed from a print control apparatus 100, and the print control apparatus 100 that controls the printer 200.

The print control apparatus 100 includes an input unit 110, a display unit 120, a volatile memory 130, a non-volatile memory 140, a communication interface unit 150, a printer driver unit 160, a pop-up menu unit 170, and a control unit 180. The print control apparatus 100 may be, for example, a personal computer (PC), a personal digital assistant (PDA) and the like.

The input unit 110 is provided with at least one button for inputting various user commands, and may be, for example, a keyboard, a mouse and the like. The input unit 110 may select a printer driver to be applied and a print option required for the printing, as well as inputting a printing command.

The user command signal input through the input unit 110 is provided to the control unit 180, and the control unit 180 controls the print control apparatus 100 in response to the input user command signal. For example, when a button of a mouse 110 is clicked, the signal is fed to the control unit 180, and the control unit 180 controls the print control apparatus 100 in response to the input signal.

The display unit 120 displays, among other information, various user notification messages. For example, the display unit may display a notification message corresponding to the user command, under the control of the control unit 180. For example, when a right mouse button is clicked, the display unit 120 displays pop-up menus 410 generated by the pop-up menu unit 170. In the case where any one of the mouse pop-up menus 410 is clicked and there is a pop-up menu subordinating to the clicked menu (referred to as a pop-up submenu), the display unit 120 may display the pop-up submenu generated by the pop-up menu unit 170.

The volatile memory 130 temporarily stores data produced by various operation of the print control apparatus 100 under the control of the control unit 180.

The non-volatile memory 140 stores a program for generally controlling the print control apparatus 100.

The communication interface unit 150 is connected to the printer 200 by wireless or wired connection, which serves as a data path when data is exchanged between the print control apparatus 100 and the printer 200.

The printer driver unit 160 converts a file to be printed into a language readable by the printer 200, for example, a printer description language (PDL). If the printer driver and the print option are selected on the pop-up menu by the input unit 110, the communication interface unit 150 receives the selected printer driver and print option from the printer driver unit 160 under the control of the control unit 110, and then transfers the file to be printed and the selected print option to the printer 200 connected to the selected printer driver.

The printer driver unit 160 may include at least one printer driver. Since the printer control apparatus 100 is connected to at least one or more printers, the printer driver unit 160 may include at least one or more printer driver for driving each printer.

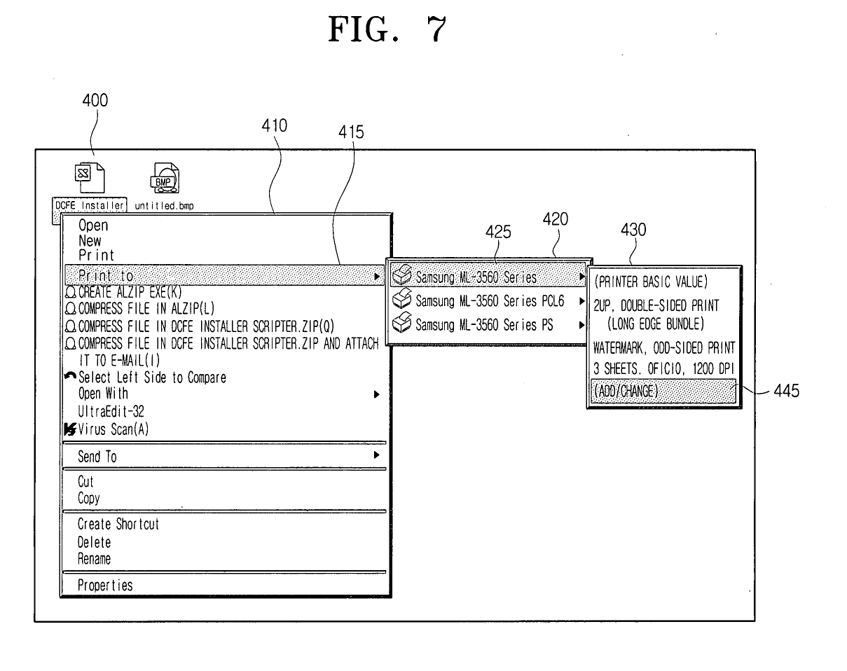

Further, the printer driver provided in the printer driver unit 160 may include at least one profile. The profile may contain information on various options required for the printing. Referring to FIG. 6, a changed basic value of an option required for printing (for example, the number of pages of each printed page, output order, or the like) may be saved as one profile. Therefore, only the corresponding profile need be selected and used for printing, without individually changing the option again because the changed option is again applied to print the file. Herein, the print option refers to an option required for the printing, and includes a profile in which various options required for the printing are previously defined.

When a printer driver is installed, the printer driver unit 160 transfers printer driver information to the pop-up menu unit 170 to register the printer driver in the pop-up menu.

The pop-up menu unit 170 generates a pop-up menu 410, as shown in FIG. 5. After appropriate selection, the pop-up menu unit 170 generates a pop-up submenu 420 (hereinafter referred to as a “first menu”) including a list of printer drivers installed in the printer control apparatus 100, and a pop-up submenu 430 (hereinafter referred to as a “second menu”) including a list of profiles stored in the printer driver selected on the first menu. If the printer driver is installed, the pop-up menu unit 170 receives information of the printer driver from the printer driver unit 160 to register the printer driver in the first menu 420.

When an icon 400 of a file to be printed is appropriately selected, for example by clicking the right mouse button, the pop-up menu unit 170 transfers the pop-up menu 410 to the display unit 120 under the control of the control unit 180.

When the “Print” menu of the pop-up menu is selected, for example if it is clicked, the pop-up menu unit 170 according to another exemplary embodiment of the present invention may generate an appropriate pop-up submenu (hereinafter referred to as a “first menu”) including print options, which are frequently used among default profile values of the printer driver installed in the print control apparatus as a default, and may additionally generate a pop-up submenu (hereinafter referred to as a “second menu”) including a list of the frequently-used print options.

The second menu may show a list of the print options with a check box through which a user can selectively add desired print options to the first menu.

Additionally, when an icon of at least one file to be printed is selected and a right mouse button is clicked, the pop-up menu of the pop-up menu unit 170 is transferred to the display unit 120 under the control of the control unit 180.

When the “Print to” menu 415 of the pop-up menu 410 displayed by the display unit 120 is selected, for example if it is clicked, the pop-up menu unit 170 transfers an appropriate first menu 420 to the display unit 120. Data for the first menu 420 may be registered in the installed printer driver or drivers.

Alternatively, the pop-up menu unit 170 may search for the printer driver installed in the print control apparatus 100 from the printer driver unit 160, and transfer the list to the display unit 120 in the form of the first menu 420.

When any one printer driver of the first menu 420 is clicked and selected, the pop-up menu unit 170 searches for the profile stored in the selected printer driver from the printer driver unit 160, and transfers the list to the display unit 120 in the form of the second menu 430.

Alternatively, the pop-up menu unit 170 may transfer the print option, which is frequently used among default profile values of the printer installed in the print control apparatus 100 as a default, to the display unit 120 in the form of the first menu.

In addition, when an “Add” menu of the first menu is selected, for example if it is clicked, the pop-up menu unit 170 may transfer the list of the print options to be added to the first menu, to the display unit 120 in the form of the second menu.

The control unit 180 generally controls the print control apparatus 100 according to the program stored in the non-volatile memory 140.

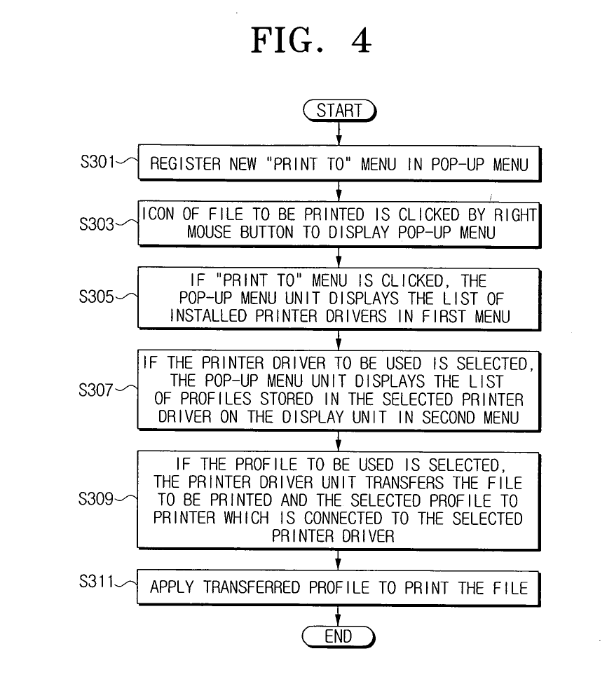

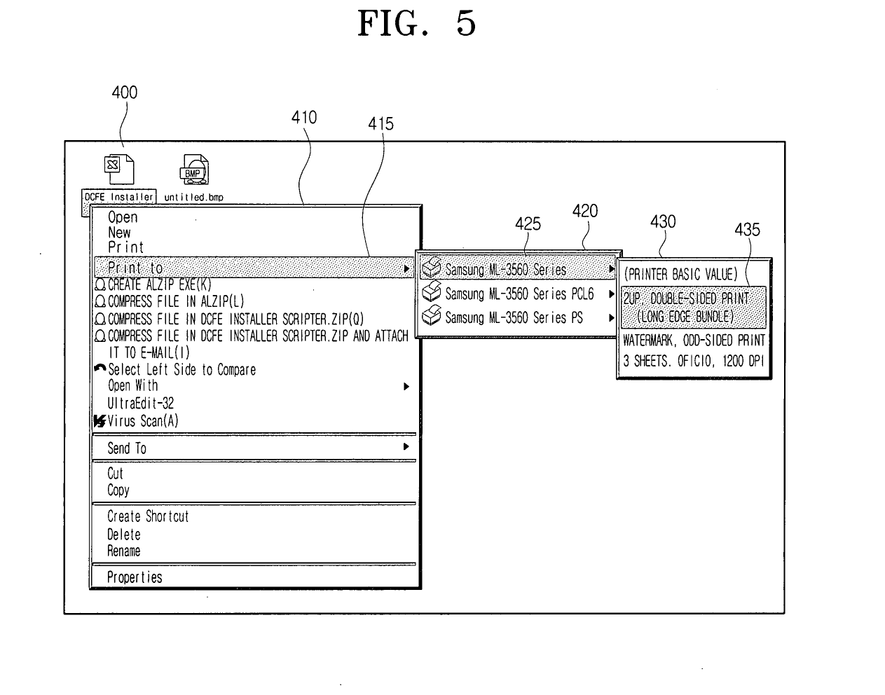

FIG. 4 is a flowchart explaining the printing method according to an exemplary embodiment of the present invention. The printing method of the present invention will now be described with reference to FIGS. 4 and 5.

The pop-up menu unit 170 registers the “Print to” menu in a conventional pop-up menu 170 (S301). Hence, the function of the conventional “Print” menu may be utilized intact.

When the icon 400 of the file to be printed is selected, for example by clicking the right button of the mouse 110, the pop-up menu unit 170 displays the pop-up menu 410 on the display unit 120 (S303). The pop-up menu 410 is previously registered in the “Print to” menu.

When the “Print to” menu 415 is selected, for example if it is clicked, the pop-up menu unit 170 displays the list of at least one printer driver installed in the print control apparatus 100 on the display unit 120 (S305). If the printer driver is installed, the pop-up menu unit 170 previously receives the corresponding printer driver information from the printer driver unit 160 and registers it for display in the first menu 420. Thus, when the “Print to” menu 415 is clicked, the pop-up menu unit 170 displays the first menu 420 on the display unit 120.

Alternatively, when the “Print to” menu 415 is clicked, the pop-up menu unit 170 searches for at least one printer driver installed in the print control apparatus 100 from the printer driver unit 160, and displays the list of installed printer devices on the display unit 120 in the form of the first menu 420. As shown in FIG. 5, an exemplary print control apparatus 100 includes three printer drivers, for example, “Samsung ML-3560 Series”, “Samsung ML-3560 Series PCL 6”, and “Samsung ML-3560 Series PS”.

If the printer driver to be used is selected, the pop-up menu unit 170 displays the list of at least one profile stored in the selected printer driver on the display unit 120 in the form of the second menu 430 (S307). For example, if the printer driver 425, in other words, “Samsung ML-3560 Series”, of the first menu 420 is clicked and selected, the pop-up menu unit 170 searches the profile stored in the printer driver 425 of “Samsung ML-3560 Series” from the printer driver unit 160, and displays the profile list on the display unit 120 in the form of the second menu 430. Referring to FIG. 5, as an example the printer driver of “Samsung ML-3560 Series” includes four profiles, in other words, “<printer basic value>”, “2UP, double-sided print”, “watermark, odd-sided print”, and “3 sheets, Oficio, 1200 dpi”.

FIG. 6 is a view explaining an exemplary method of storing a profile. For example, after a basic value of an option required for the printing (for example, the number of pages for each printed page, output order, or the like) is changed, and a name of the profile is set in a batch designation 500, the profile having the information on the changed option is saved by pressing a “SAVE” button 510. Hence, if the previously changed option is again applied to print the file, only the corresponding profile is selected to print the file, without individually changing the option. Referring to FIG. 6, the printer driver includes four profiles 520, in other words, “basic value”, “2UP, double-sided print”, “watermark, odd-sided print”, and “3 sheets, Oficio, 1200 dpi”. Since the list of the stored profiles is displayed in the type of the second menu 430, it is preferable that the name of the profile is saved so that a user can see the contents of the profile through the name.

If the profile to be used is selected, the printer driver unit 160 transfers the file to be printed and the selected profile to the printer 200 which is connected to the selected printer driver, through the communication interface unit 150 under the control of the control unit 180 (S309). For example, the printer 425 of “Samsung ML-3560 Series” receives a profile 435 of “2UP, double-sided print (long edge bundle)” and the file to be printed.

The printer 200 applies the transferred profile to print the file (S311).

FIG. 7 is a view illustrating a pop-up menu according to another exemplary embodiment of the present invention. In the example of printing the file by applying another print option, in addition to the profile displayed on the second menu 430, there is a drawback in that the user separately opens the user interface provided by the printer driver as shown in FIG. 6, alters and saves the desired print option as other profile, and again uses the pop-up menu.

Therefore, a menu 445 for changing the print option may be added to the second menu 430, as shown in FIG. 7. When the user selects an “Add/Alter” menu 445 which is a menu capable of changing the print option, the user interface, for example, the user interface as shown in FIG. 6, for adding or changing the print option is displayed. If the user adds or alters the desired print option and presses the “Apply” button in FIG. 6, the printer driver unit 160 transfers the file to be printed and the print option to the printer 200 which is connected to the selected printer driver, through the communication interface unit 150 under the control of the controller 180 (S309). The printer 200 applies the transferred print option to print the file (S311).

The printer driver unit 160 and the pop-up menu unit 170 may be achieved by a program installed in the non-volatile memory 140.

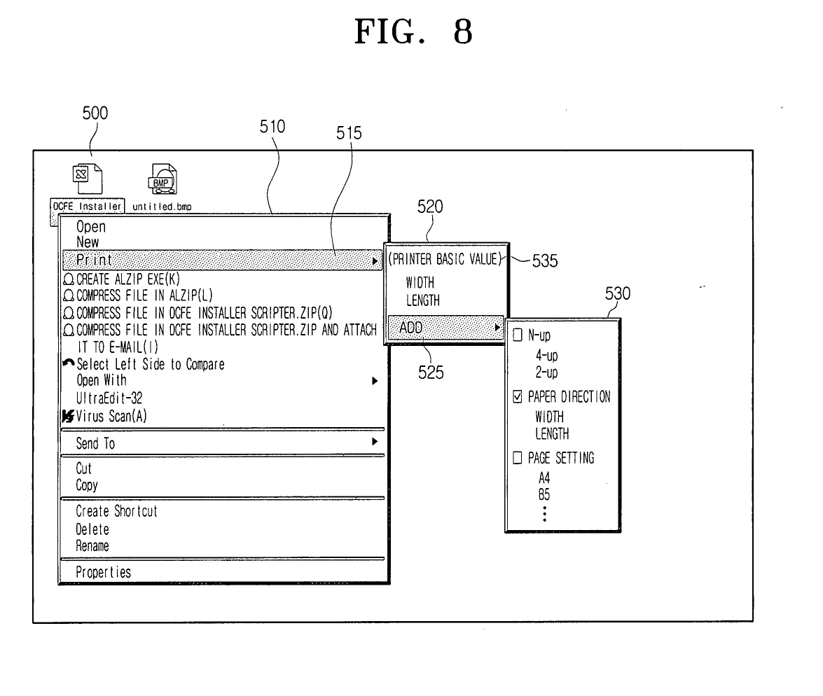

FIG. 8 is a view illustrating a pop-up menu according to another exemplary embodiment of the present invention.

Referring to FIG. 8, when an icon 500 of a file to be printed is selected, for example by clicking a right mouse button, a pop-up menu 510 is displayed.

When the “Print” menu 515 of the displayed pop-up menu 510 is selected, a first menu 520 including print options, which are frequently used among default profile values of the printer installed in the print control apparatus as a default, is displayed.

For example, when the “width” or “length” print option is selected through the displayed first menu 520, the file to be printed and the selected “width” or “length” print option are transferred to the printer installed as the default, and the printer applies the transferred “width” or “length” print option in printing the file.

The previous print options may also be utilized by selecting the “printer basic value” menu 535.

When the “Add” menu 525 of the first menu 520 is clicked, a second menu 530 including a list of the print options to be added to the first menu 520, is displayed.

In other words, when a user selects a frequently used print option from the second menu 530, for example “paper direction,” the selected print option is added to the first menu 520 so that the printer can apply the selected print option in printing the file.

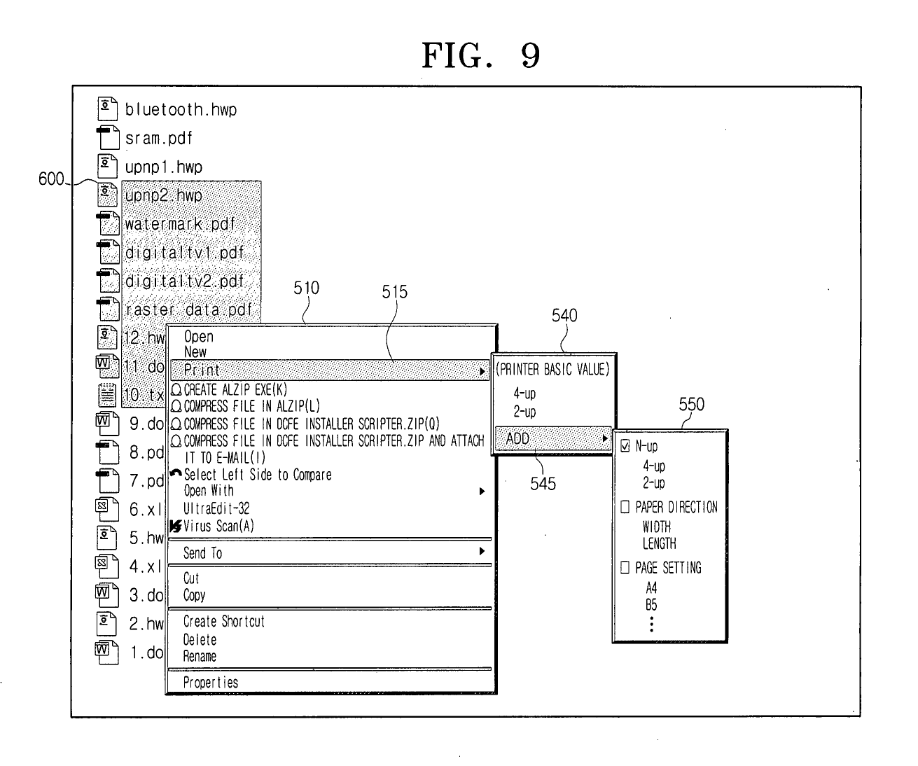

FIG. 9 is a view illustrating a pop-up menu according to another exemplary embodiment of the present invention.

Referring to FIG. 9, when a plurality of files 600, are selected and the right mouse button is clicked or the files are otherwise selected, the pop-up menu 510 is displayed.

When the “Print” menu 515 of the displayed pop-up menu 510 is clicked, the first menu 540 including print options, which are frequently used among default profile values of the printer installed in the print control apparatus as a default, is displayed.

For example, when N-up print option is selected from the displayed first menu 540, the files to be printed and the selected N-up print option are transferred to the printer installed as a default, and the printer applies the transferred N-up print option in printing the files.

Even when the plurality of files 600 to be printed is created in different application programs, the selected N-up print option can be applied and the corresponding application programs do not need to be open.

Since the N-up print option is applied to the plurality of files 600 to be printed, the files can be printed consecutively. Therefore, the files can be efficiently printed without loss of print papers.

Similarly to FIG. 8, when the “Add” menu 545 of the first menu 540 is clicked, a second menu 550 including a list of the print options to be added to the first menu 540 is displayed, and selected. Although it is exemplified that one print option is selected in this exemplary embodiment, one will appreciate that a plurality of options can be selected, and the present invention is not limited thereto.

As described above, according to an exemplary embodiment of the present invention, since lists of print options and printer drivers are displayed on a mouse pop-up menu to allow a user to select a desired print option and print driver, it is not required for the user to open the file to be printed in order to select the corresponding printer driver and print option.

The foregoing embodiments and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. A method of printing a file to be printed using a pop-up menu, the method comprising:
displaying a pop-up menu for a file to be printed;
selecting a printer driver and a print option for a print operation through the pop-up menu; and
printing the file using the selected printer driver and print option.

2. The method as claimed in claim 1, wherein the displaying of the pop-up menu for a file to be printed comprises clicking an icon of the file to be printed using a right mouse button.

3. The method as claimed in claim 1, wherein the pop-up menu includes a first menu for showing a list of selectable printer drivers, and a second menu for showing a list of selectable print options.

4. The method as claimed in claim 3, wherein the selecting of the printer driver and the print option for a print operation through the pop-up menu comprises selecting the printer driver from the displayed list of the selectable printer drivers.

5. The method as claimed in claim 3, wherein the selecting of the printer driver and the print option for a print operation through the pop-up menu comprises selecting the print option from the displayed list of the selectable print options.

6. The method as claimed in claim 1, further comprising registering the printer driver in the pop-up menu when the printer driver is installed.

7. The method of printing the file as claimed in claim 1, wherein the pop-up menu comprises a menu capable of at least one of adding another print option and changing the print option;
wherein the selecting of the printer driver and the print option for a print operation through the pop-up menu comprises selecting the print option through a user interface capable of adding or changing the print option if the menu capable of adding or changing the print option is selected.

8. The method as claimed in claim 1, wherein the pop-up menu includes a first menu for showing print options and a second menu for showing a list of print options to add to the first menu when the print driver is installed as a default.

9. The method as claimed in claim 8, wherein the second menu includes a check box for selecting the print option on the list to add to the first menu.

10. The method as claimed in claim 8, wherein the file to be printed comprises at least one file.

11. A print control apparatus for printing a file using a pop-up menu, the apparatus comprising:
a pop-up menu unit for generating a pop-up menu;
a display unit for displaying the generated pop-up menu;
an input unit for selecting a printer driver and a print option for a print operation through the pop-up menu; and
a communication interface unit for transmitting the selected printer driver and print option to a printer connected to the printer driver.

12. The print control apparatus as claimed in claim 11, wherein the input unit is a mouse.

13. The print control apparatus as claimed in claim 11, wherein the pop-up menu includes a first menu for showing a list of selectable printer drivers and a second menu for showing a list of selectable print options.

14. The print control apparatus as claimed in claim 13, wherein the input unit selects the printer driver from the displayed list of the selectable printer drivers.

15. The print control apparatus as claimed in claim 13, wherein the input unit selects the print option from the displayed list of the selectable print options.

16. The print control apparatus as claimed in claim 11, wherein the mouse pop-up menu unit registers the printer driver in the pop-up menu if the printer driver is installed.

17. The print control apparatus as claimed in claim 13, further comprising at least one printer driver and at least one print option for each printer driver;
wherein the list of the selectable printer drivers is extracted from the printer driver.

18. The print control apparatus as claimed in claim 13, further comprising at least one printer driver and at least one print option for each printer driver;
wherein the list of the selectable print options is extracted from the printer driver.

19. The print control apparatus as claimed in claim 11, wherein the pop-up menu includes a menu capable of adding or changing the print option;
wherein if the menu capable of adding or changing the print option is selected, the input unit selects the print option through a user interface capable of adding or changing the print option.

20. The print control apparatus as claimed in claim 11, wherein the pop-up menu includes a first menu for showing print options and a second menu for showing a list of print options to add to the first menu when the print driver is installed as a default.

21. The print control apparatus as claimed in claim 20, wherein the second menu includes a check box for selecting the print option on the list to add to the first menu.

22. The print control apparatus as claimed in claim 20, wherein the file to be printed comprises at least one file.

23. A method of printing a file using a pop-up menu, the method comprising:
displaying a pop-up menu for a file to be printed;
selecting a printer driver for a print operation through the pop-up menu; and
printing the file by applying the selected printer driver.

24. The method as claimed in claim 23, further comprising selecting a print option for the print operation through the pop-up menu.

25. The method as claimed in claim 23, wherein the displaying of the pop-up menu comprises selecting an icon of the file to be printed using a mouse.

26. The method as claimed in claim 24, wherein the displaying of the pop-up menu comprises displaying a first sub-menu comprising a list of printer drivers and a second sub-menu comprising a list of print options.
